(19) United States
(12) Patent Application Publication
(10) Pub. No.: US 2013/0278832 A1
(43) Pub. Date: Oct. 24, 2013

(54) Digital Television System and Receiver for Providing Information of Point of Interest

(71) Applicant: MStar Semiconductor, Inc., Hsinchu Hsien (TW)

(72) Inventors: Meng-Shu Lee, Hsinchu Hsien (TW); Yung-Chi Fan, Hsinchu Hsien (TW)

(21) Appl. No.: 13/921,453

(22) Filed: Jun. 19, 2013

Related U.S. Application Data
(63) Continuation-in-part of application No. 12/487,870, filed on Jun. 19, 2009.

(30) Foreign Application Priority Data
Feb. 17, 2009 (TW) 098104898

(51) Int. Cl. H04N 5/44

(52) U.S. Cl. CPC H04N 5/4403
USPC 348/725; 348/723

(57) ABSTRACT

The present invention provides a digital TV system comprising a transmitter and a receiver. The transmitter comprises an encoder and a combiner. The encoder encodes information of point of interest (POI) into POI packets. The combiner adds the POI packets to vertical blanking intervals (VBIs) of TV data according to synchronous information of the TV data to form the TV signal. The receiver comprises a video decoder, a user interface, and a VBI decoder. The video decoder decodes video data of the TV signal and outputs the decoded video data to a display device. The user interface receives a select signal triggered by a user to select one or more images of the decoded video data upon the decoded video data being displayed on the display device. The VBI decoder determines and decodes a target POI packet from the POI packets according to the selected signal.

### CROSS REFERENCE TO RELATED PATENT APPLICATION

This is a continuation-in-part application of U.S. application Ser. No. 12/487,870, filed on Jun. 19, 2009. This patent application is based on a Taiwan, R.O.C. patent application No. 98104898 filed on Feb. 17, 2009.

### FIELD OF THE INVENTION

The present invention relates to a digital television (TV) system, and more particularly, to a digital TV receiver and system and associated method for providing information of points of interest (POIs).

### BACKGROUND OF THE INVENTION

At present, Digital Video Broadcasting (DVB) is one of the main transmission standards applied to the digital TV system. As the DVB standard is widely used in mobile digital TV devices, a user is able to watch a digital TV conveniently while walking or riding on a vehicle.

However, when watching a certain program or advertisement of the digital TV, the user can not conveniently or immediately obtain further information associated with POIs, such as stores, restaurants, scenic areas, and so on, shown in the program or advertisement. For example, the information of a POI can include a phone number, an address, a longitudinal and latitudinal position, and service hours of the POI. The user himself has to search the Internet or call a TV station to obtain such information. Especially, when the user is using the mobile digital TV while traveling outdoors, it is not convenient to search the Internet to obtain the information of the POIs. In other words, the current digital TV service including the mobile digital TV service does not provide detailed information of POIs associated with a program or advertisement, which causes inconvenience for the user.

### SUMMARY OF THE INVENTION

In view of the foregoing issues, one object of the present invention is to provide a digital TV receiver and system and associated method for providing information of a POI. Therefore, information of the POI associated with a program or advertisement is provided to a user conveniently and immediately.

According to the present invention, a digital TV system comprises a transmitter and a receiver. The transmitter is for transmitting a television (TV) signal and comprises an encoder and a combiner. The encoder is for encoding information of point of interest (POI) into POI packets. The combiner is for adding the POI packets to vertical blanking intervals (VBIs) of TV data according to synchronous information of the TV data to form the TV signal. The receiver is for receiving the TV signal and comprises a video decoder, a user interface, and a VBI decoder. The video decoder is for decoding video data of the TV signal and outputting the decoded video data to a display device. The user interface is for receiving a select signal triggered by a user to select one or more images of the decoded video data upon the decoded video data being displayed on the display device. The VBI decoder is for determining and decoding a target POI packet, corresponding to the selected one or more images, from the POI packets according to the selected signal.

Moreover, according to the present invention, a receiver for receiving a TV signal is provided. The receiver comprises a video decoder, a user interface, and a VBI decoder. The video decoder is for decoding video data of the TV signal and outputting the decoded video data to a display device. The user interface is for receiving a select signal triggered by a user to select one or more images of the decoded video data upon the decoded video data being displayed on the display device. The VBI decoder is for determining and decoding a target POI packet, corresponding to the selected one or more images, from the POI packets according to the selected signal.

Furthermore, according to another aspect of the present invention, a receiver for receiving a TV signal is provided. The receiver comprises a memory, a video decoder, a VBI decoder, a user interface, and a POI unit. The video decoder is for decoding video data of the TV signal and outputting the decoded video data to a display device. The VBI decoder is for decoding the POI packets of the TV signal, and storing the decoded data of the POI packets in the memory. The user interface is for receiving a select signal triggered by a user to select one or more images of the decoded video data upon the decoded video data being displayed on the display device. The POI unit is for obtaining decoded data of a target POI packet, corresponding to the selected one or more images, among the POI packets from the memory according to the selected signal.

### BRIEF DESCRIPTION OF THE DRAWINGS

FIG. 1A is a block diagram of a DVB system in accordance with an embodiment of the present invention.

FIG. 1B shows a format of a PES packet.

FIG. 1C is a block diagram of a DVB receiver shown in FIG. 1A in accordance with an embodiment of the present invention.

FIG. 1D is a block diagram of a DVB receiver in accordance with another embodiment of the present invention.

FIG. 2 is a block diagram of a DVB receiver in accordance with an embodiment of the present invention.

FIG. 3 is a flow chart of a method for providing information of a POI in accordance with an embodiment of the present invention.

FIG. 4 is a flow chart of a method for providing information of a POI in accordance with another embodiment of the present invention.

FIG. 5 is a block diagram of a DVB transmitter in accordance with an embodiment of the present invention.

### DETAILED DESCRIPTION OF THE PREFERRED EMBODIMENT

Common digital TV systems comprise the DVB system, the Advance Television Systems Committee (ATSC) system specified by the ATSC, the Integrated Services Digital Broadcasting (ISDB) system, and the Digital Multimedia Broadcast (DMB) system. The digital TV systems are generally classified into wired systems and wireless systems. The system and method thereof, provided according to the present invention, for providing information of POIs of TV programs or advertisements, can be applied to the foregoing digital TV systems. The following description takes the DVB system as an example to describe the system and method thereof of the present invention; however, it shall not be construed as limiting the scope of inventive concepts disclosed and/or claimed herein.

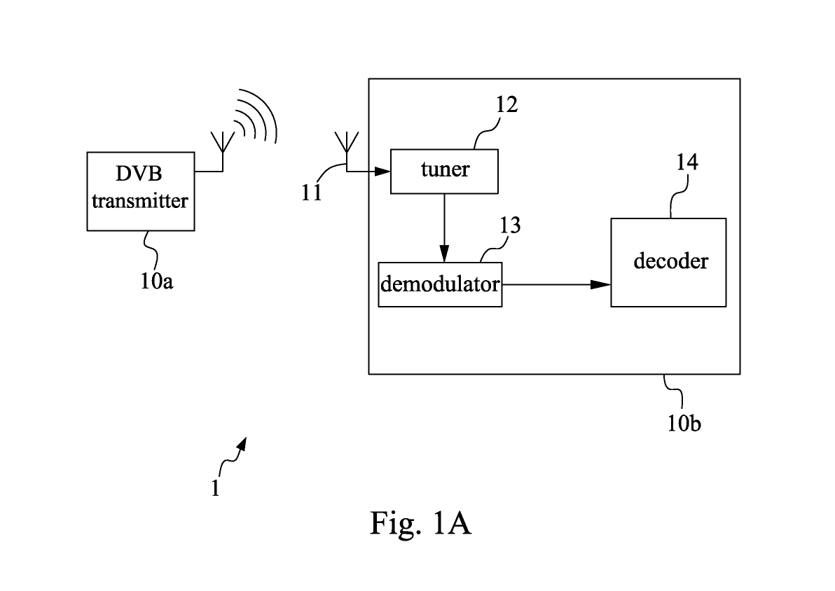

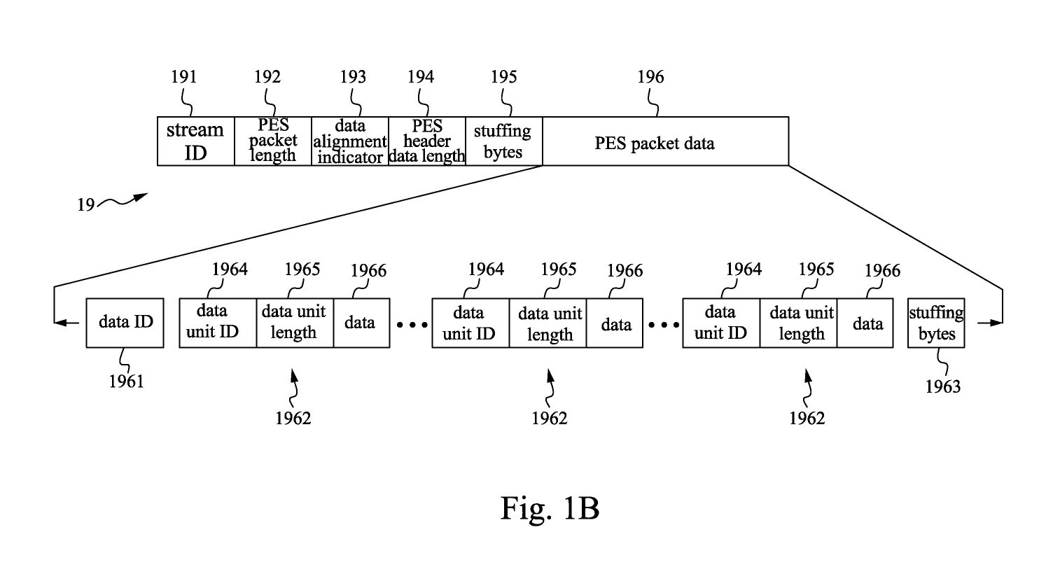

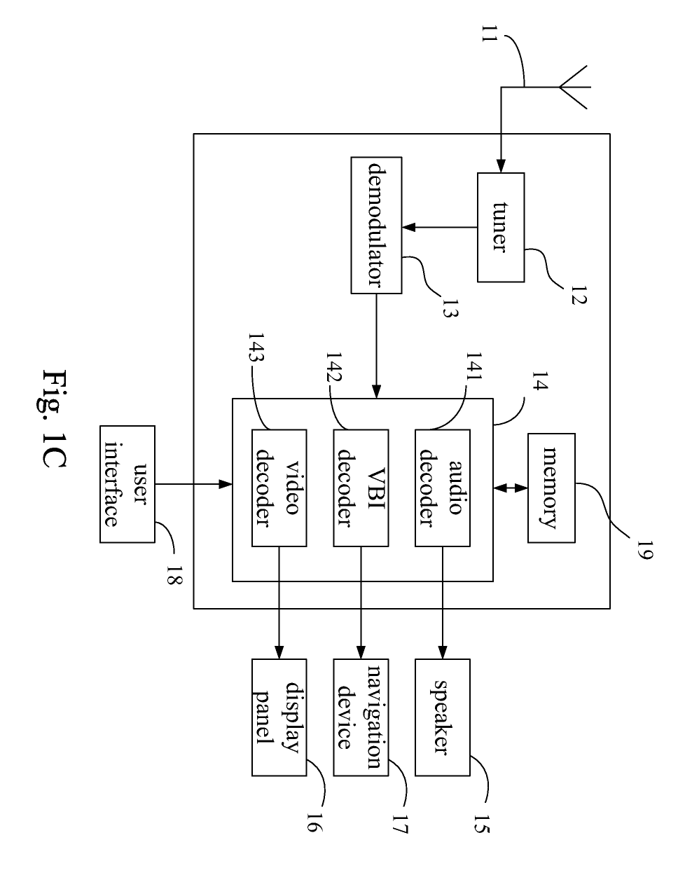

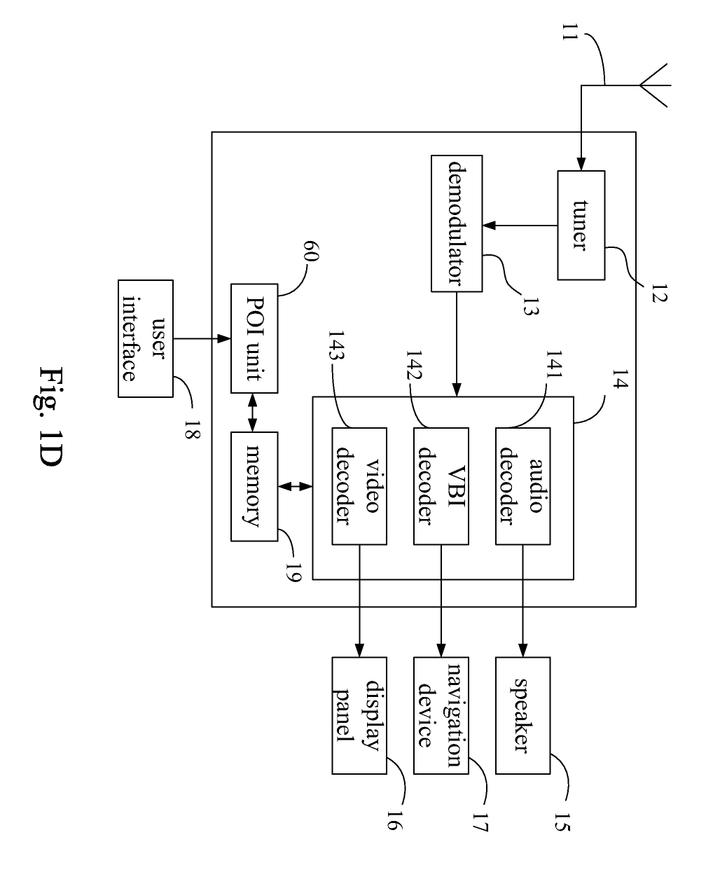

FIG. 1A is a block diagram of a DVB system in accordance with an embodiment of the present invention. A DVB system 1 comprises a DVB transmitter 10a, and a DVB receiver 10b. The DVB receiver 10b comprises an antenna 11, a tuner 12, a demodulator 13 and a decoder 14. In this embodiment, a DVB service provider such as a TV station or a mobile communication service provider adds information of a POI which is relating to a DVB audio-video (AV) data such as a program or an advertisement into the DVB AV data in advance at a transmitting end. For example, the information of the POI may include a name, a phone number, a longitudinal and latitudinal position, an address, service hours, a menu, and a sales promotion message of the POI, and so on. The DVB AV data is encoded to generate a DVB signal, which is then modulated and converted to a radio frequency (RF) signal to be transmitted via the DVB transmitter 10a. The DVB receiver 10b at a receiving end receives the DVB RF signal via the antenna 11. The tuner 12 converts the DVB RF signal into an intermediate frequency (IF) signal and then transmits the IF signal to the demodulator 13. The demodulator 13 converts the analog IF signal to a digital stream signal which is the original DVB signal. The decoder 14 decodes the DVB signal to generate the DVB AV data and the information of the POI added at the transmitting end. The information of the POI decoded by the decoder 14 can be directly provided to a user for reference. For example, the information of the POI can be displayed on a display device (not shown) coupled to the decoder 14. Moreover, the information of the POI can be transmitted to other hardware devices or application software that is capable of providing location based service, such as an electronic device (not shown) having a navigation function. Accordingly, the electronic device can find a nearest POI and navigating to the nearest POI. In an embodiment, the information of the POI decoded by the decoder 14 can be provided to an electronic device having an electronic map, so as to mark the location of the POI on the electronic map.

Within the DVB AV data, a vertical blanking interval (VBI) exists between every two frame data or field data. The information of the POI is encoded to a Packetized Elementary Stream (PES) packet and added into the VBI. For example, a PES packet data field of the PES packet is used for storing the information of the POI. The format of the PES packet is illustrated in FIG. 1B. A PES packet 19 comprises a stream identification (ID) 191, a PES packet length 192, a data alignment indicator 193, a PES header data length 194, stuffing bytes 195, and a PES packet data 196. The field of the PES packet data 196 is subdivided into fields of a data ID 1961, a plurality of data units 1962 and stuffing bytes 1963. In this embodiment, the data ID field 1961 is set as a predetermined value to indicate that the field of the PES packet data 196 is stored with the information of the POI. Each of the data unit 1962, comprising fields of a data unit ID 1964, a data unit length 1965 and a data 1966, stores with certain information of the POI. For instance, if the data unit ID 1964 is “01”, it means that the data unit 1962 is stored with the name of the POI; if the data unit ID 1964 is “02”, it means that the data unit 1962 is stored with the phone number of the POI; and so on. The stuffing bytes 1963 are used for complementing the length needed by the field of the PES packet data 196.

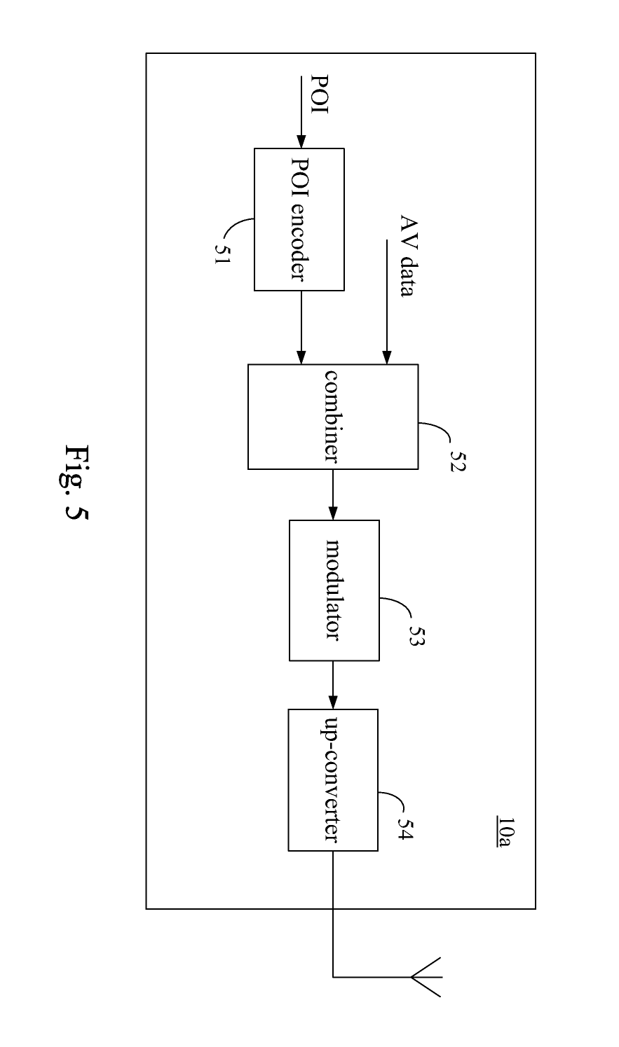

FIG. 5 is a block diagram of a DVB transmitter in accordance with an embodiment of the present invention. The DVB transmitter 10a shown in FIG. 5 comprises a POI encoder 51, a combiner 52, a modulator 53, and an up-converter 54. The POI encoder 52 receives information of POI which is related to the AV data and encodes the information of POI to form POI packets. The POI packets can be PES packets. The combiner 52 receives the POI packets and the AV data and adds the POI packets into vertical blanking intervals of the AV data to form the TV signal. The combiner 52 can utilize synchronous information of the AV data to find positions of the vertical blanking intervals of the AV data and then the POI packets can be added into the vertical blanking intervals. Each of the POI packets is related to a relating image of the AV data. For easy acquiring a POI packet corresponding to a relating image when the relating image is displayed, it is preferable to add the POI packet into a vertical blanking interval near the data of the relating image. It means that the POI packets are preferably added into vertical blanking intervals which are near the data of their relating images, respectively. In one embodiment, the combiner 52 can be implemented by a multiplexer. Then, the TV signal is modulated by the modulator 53, up-converted by the up-converter 54, and transmitted out by the antenna.

In this embodiment, the decoder 14 comprises an audio decoder 141, a VBI decoder 142 and a video decoder 143 as shown in FIG. 1C. The DVB signal outputted by the demodulator 13 comprises an audio stream, a VBI stream and a video stream. The audio decoder 141 decodes the audio stream and outputs the decoded result to a speaker 15. The video decoder 143 decodes the video stream and outputs the decoded result to a display panel 16. The VBI decoder 142 decodes the VBI stream to generate the information of the POI contained in the VBI stream. The VBI decoder 142 can output the information of the POI to a navigation device 17, such as a personal digital assistant (PDA) or a mobile phone with navigating function, so as to perform navigation or mark the position of the POI on the electronic map.

In this embodiment, the DVB signal outputted by the demodulator 13 comprises a large number of images of the DVB AV data broadcasted by the provider and the related information of the POI included in each of the images. The decoder 14 of the DVB receiver 10b can receive a select signal inputted by the user via a user interface 18, so as to select a certain image or images of a certain segment of the DVB signal. For example, when the display panel 16 has a touch control function, the user can select a current display image by touching the display panel 16 directly. The decoder 14 decodes the DVB signal according to the select signal, so as to generate the information of the POI of the selected image and provide the information to the user. For instance, the information of the POI can be displayed on the display panel 16.

In another embodiment, POI packets within the demodulated TV signal are stored in the memory 19 by the decoder 14. Information about the POI packets stored in the memory can be recorded in a table. Addresses at which the POI packets are stored and information of relating images corresponding to the stored POI packets are recorded in the table. The video decoder 143 continues to decode video data of the demodulated TV signal, and output the decoded video data to the display panel for displaying. Upon watching TV programs, a user can select one or more images which are being displayed on the display panel by triggering a select signal to the decoder 14 through the user interface 18 when he/she is interested in the one or more images. Then, the VBI decoder 142 determines at least one target POI packet from the POI packets stored in the memory 19 according to the selected one or more images by looking up the table, and decodes the target POI packet to obtain the decoded data of the target POI packet to be displayed on the display panel 16. For reducing the capacity requirement of the memory 19, only a limited number of the POI packets are stored in the memory 19. For example, only the POI packets corresponding to the last one-minute images displayed on the display panel are stored in the memory 19.

FIG. 1D shows a block diagram of a DVB receiver in accordance with another embodiment of the present invention. In this embodiment, when the video decoder 143 continues to decode video data of the demodulated TV signal, the VBI decoder 142 also continues to decode received POI packets of the demodulated and stores the decoded data of the POI packets in the memory 19. It is preferable to build a table to record information about the decoded data stored in the memory 19. For example, addresses at which the decoded data for each POI packets is stored and information of relating images corresponding to the POI packets are recorded in the table. Upon watching TV programs, a user can select one or more images which are being displayed on the display panel by triggering a select signal to the POI unit 60 through the user interface 18 when he/she is interested in the one or more images. Then, the POI unit 60 determines decoded data of a target POI packet stored in the memory 19 according to the selected one or more images by looking up the table, and outputs the determined decoded data to be displayed on the display panel 16. The POI unit 60 can be implemented by software. Similarly, for reducing the capacity requirement of the memory 19, only the decoded data of a limited number of the POI packets are stored in the memory 19. For example, only decoded data of the POI packets corresponding to the last one-minute images displayed on the display panel is stored in the memory 19.

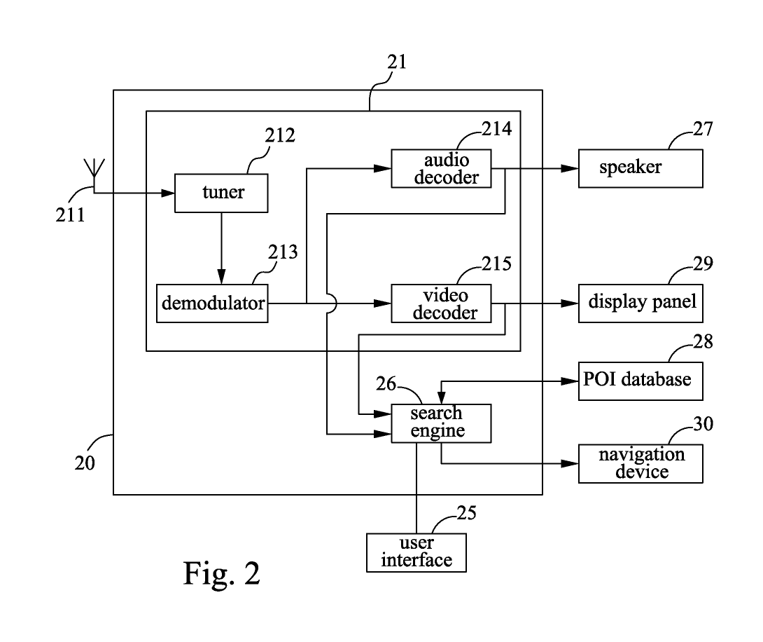

FIG. 2 is a block diagram of a DVB receiver in accordance with an embodiment of the present invention. The DVB receiver 20 comprises a signal processing module 21 and a search engine 26. The signal processing module 21 comprises an antenna 211, a tuner 212, a demodulator 213, an audio decoder 214 and a video decoder 215. The antenna 211 receives a DVB RF signal sent from a transmitting end of a system provider. The tuner 212 converts the DVB RF signal to an IF signal to be transmitted to the demodulator 213. The demodulator 213 converts the analog IF signal to a digital stream signal such as a DVB signal. The digital stream signal comprises an audio stream and a video stream, which are sent to the audio decoder 214 and the video decoder 215 respectively. The audio decoder 214 decodes the audio stream to generate an audio data, which is outputted to be played by a speaker 27 and is also sent to the search engine 26. The search engine 26 is coupled to a POI database 28 which is stored with a plurality of POIs and their associated information. The search engine performs audio recognition on the audio data, so as to recognize the POI included in the audio data, such as a name of the POI. On the other hand, the video decoder 215 decodes the video stream to generate a video data, which is outputted to be displayed by a display panel 29 and is also sent to the search engine 26. The search engine performs image recognition on the video data. For example, the search engine performs optical character recognition to recognize the POI included in the video data, such as a name or trademark of the POI. The search engine 26 then utilizes the POI recognized from the audio data or the video data to search the POI database 28. When a same or similar POI is found, information of the POI is accessed from the POI database 28. In FIG. 2, the POI database 28 is outside the DVB receiver 20 and is connected to the DVB receiver 20 via a wired or wireless manner. For example, when the DVB receiver 20 is integrated to a mobile phone and the POI database 28 is on a server of a mobile system provider, the DVB receiver 20 accesses the POI database 28 at a remote end via the mobile phone. In another embodiment, the POI database 28 can be integrated inside the DVB receiver 20.

In a preferred embodiment, the stream signal generated by the demodulator 213 comprises a text data having subtitles of a program or an advertisement with the format of the Closed Caption system, the Teletext system, or the Subtitle system. The search engine 26 recognizes a POI from the text data of the stream signal and searches the POI database according to the POI.

In a preferred embodiment, the search engine 26 outputs the information of the POI to a navigation device 30, and then the navigation device 30 can perform navigation according to the information of the POI. In another embodiment, the DVB AV data outputted by the video decoder 215 and the audio decoder 214 comprises a large number of images. The search engine 26 of the DVB receiver 20 receives a select signal inputted by the user via a user interface 25, so as to select information included in a certain image or images of a certain segment of the DVB AV data. Then, the search engine 26 recognizes a POI from the selected image or the images of the segment of the DVB AV data and searches the POI database 28 according to the POI.

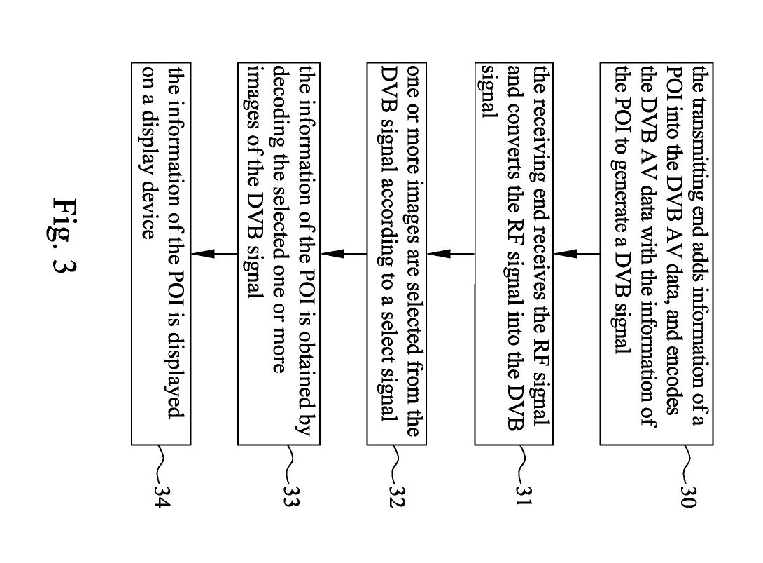

FIG. 3 is a flow chart of a method for providing information of POIs in accordance with an embodiment of the present invention. In this embodiment, the method is applied to a DVB system. In step 30, the transmitting end of the DVB system adds information of a POI, which is related to a DVB AV data or included in the DVB AV data, into the DVB AV data, and encodes the DVB AV data with the information of the POI to generate a DVB signal to be converted into an RF signal to be transmitted. In a preferred embodiment, the information of the POI is included in the VBI of the DVB signal. For example, the information of the POI is included in a PES packet of the VBI.

In step 31, the receiving end of the DVB system receives the RF signal and converts the RF signal into a baseband digital stream signal such as the DVB signal.

In step 32, one or more images are selected from the DVB signal according to a select signal inputted by a user via a user interface.

In step 33, the information of the POI is obtained by decoding the selected one or more images of the DVB signal.

In step 34, the information of the POI is displayed on a display device, so as to provide the information to the user.

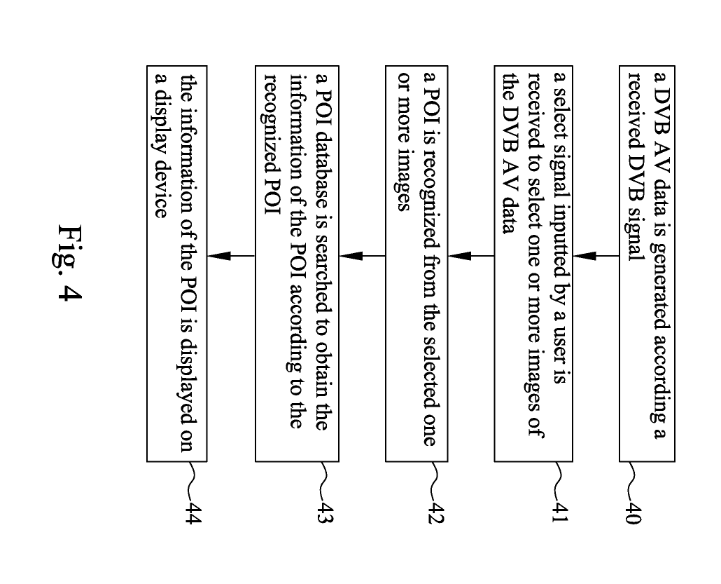

FIG. 4 is a flow chart of a method for providing information of POIs in accordance with another embodiment of the present invention. In this embodiment, the method is applied to a DVB receiver. In step 40, a DVB AV data is generated by decoding a received DVB signal. The DVB AV data comprises a video data, an audio data and a text data.

In step 41, a select signal inputted by a user is received to select one or more images of the DVB AV data.

In step 42, a POI is recognized from the selected one or more images. That is, image recognition such as optical character recognition and voice recognition is performed respectively on a video data and an audio data of selected one or more images of the DVB AV data, so as to recognize the POI.

In step 43, a POI database is searched to obtain the information of the POI according to the POI as recognized in step 42.

In step 44, the information of the POI is displayed on a display device, so as to provide the information to the user.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A digital television system, comprising:
a transmitter, for transmitting a television (TV) signal, the transmitter comprising:
an encoder, for encoding information of point of interest (POI) into POI packets; and
a combiner, for adding the POI packets to vertical blanking intervals (VBIs) of TV data according to synchronous information of the TV data to form the TV signal; and
a receiver, for receiving the TV signal, the receiver comprising:
a video decoder, for decoding video data of the TV signal and outputting the decoded video data to a display device;
a user interface, for receiving a select signal triggered by a user to select one or more images of the decoded video data upon the decoded video data being displayed on the display device; and
a VBI decoder, for determining and decoding a target POI packet, corresponding to the selected one or more images, from the POI packets according to the selected signal.

2. The digital television system as claimed in claim 1, wherein each of the POI packets is related to a relating image of the TV data and is added to one of the vertical blanking intervals which is near data of the relating image.

3. The digital television system as claimed in claim 1, wherein the receiver further comprises:
a memory, for storing a limited number of POI packets;
wherein, the VBI decoder determines the target POI packet from POI packets stored in the memory.

4. The digital television system as claimed in claim 3, wherein the VBI decoder determines the target POI packet by looking up a table which comprises information of the POI packets stored in the memory.

5. The digital television system as claimed in claim 3, wherein the limited number of POI packets stored in the memory are last received by the receiver.

6. A receiver for receiving a TV signal, the TV signal having POI packets added in vertical blanking intervals thereof, the receiver comprising:
a video decoder, for decoding video data of the TV signal and outputting the decoded video data to a display device;
a user interface, for receiving a select signal triggered by a user to select one or more images of the decoded video data upon the decoded video data being displayed on the display device; and
a VBI decoder, for determining and decoding a target POI packet, corresponding to the selected one or more images, from the POI packets according to the selected signal.

7. The digital television system as claimed in claim 6, wherein the receiver further comprises:
a memory, for storing a limited number of POI packets;
wherein, the VBI decoder determines the target POI packet from POI packets stored in the memory.

8. The digital television system as claimed in claim 7, wherein the VBI decoder determines the target POI packet by looking up a table which comprises information of the POI packets stored in the memory.

9. The digital television system as claimed in claim 7, wherein the limited number of POI packets stored in the memory are last received by the receiver.

10. A receiver for receiving a TV signal, the TV signal having POI packets added in vertical blanking intervals thereof, the receiver comprising:
a memory;
a video decoder, for decoding video data of the TV signal and outputting the decoded video data to a display device;
a VBI decoder, for decoding the POI packets of the TV signal, and storing the decoded data of the POI packets in the memory;
a user interface, for receiving a select signal triggered by a user to select one or more images of the decoded video data upon the decoded video data being displayed on the display device; and
a POI unit, for obtaining decoded data of a target POI packet, corresponding to the selected one or more images, among the POI packets from the memory according to the selected signal.

11. The digital television system as claimed in claim 10, wherein the POI unit obtains the decoded data of the target POI packet by looking up a table which comprises information about the decoded data of the POI packets.
